(19) United States
(12) Patent Application Publication
(10) Pub. No.: US 2019/0393970 A1
(43) Pub. Date: Dec. 26, 2019

(54) POSITIONING REFERENCE SIGNAL (PRS) MEASUREMENT CONSIDERATIONS FOR USER EQUIPMENTS WITHOUT FURTHER ENHANCED INTER-CELL COORDINATION INTERFERENCE CANCELLATION (FEICIC) SUPPORT IN INTERFERENCE SCENARIOS

(71) Applicant: QUALCOMM Incorporated, San Diego, CA (US)

(72) Inventors: Akash KUMAR, Hyderabad (IN); Stephen William EDGE, Escondido, CA (US); Amit JAIN, San Diego, CA (US)

(21) Appl. No.: 16/016,514

(22) Filed: Jun. 22, 2018

(51) Int. Cl. H04B 17/345; H04W 24/08; H04W 24/10; H04W 4/02

(52) U.S. Cl. CPC H04B 17/345; H04W 4/02; H04W 24/10; H04W 24/08

(57) ABSTRACT

To perform reference signal measurements of interfering cells, in an aspect, a UE determines an interference vector for each of a plurality of reference signal measurement occasions of a first cell of a plurality of cells of an interfering cell set from which to measure a reference signal, selects first and second reference signal measurement occasions, the first and second reference signal measurement occasions having a same interference vector, receives first and second measurement gaps corresponding to the first and second reference signal measurement occasions, determines, during the first measurement gap, a gain setting for measuring the reference signal transmitted during the second reference signal measurement occasion, and measures, during the second measurement gap, the reference signal using the determined gain setting.

### INTRODUCTION

Aspects of this disclosure relate generally to telecommunications, and more particularly to performing positioning reference signal (PRS) measurements of interfering cells at a user equipment (UE) and the like.

Wireless communication systems are widely deployed to provide various types of communication content, such as voice, data, multimedia, and so on. Typical wireless communication systems are multiple-access systems capable of supporting communication with multiple users by sharing available system resources (e.g., bandwidth, transmit power, etc.). Examples of such multiple-access systems include Code Division Multiple Access (CDMA) systems, Time Division Multiple Access (TDMA) systems, Frequency Division Multiple Access (FDMA) systems, Orthogonal Frequency Division Multiple Access (OFDMA) systems, and others. These systems are often deployed in conformity with specifications such as Long Term Evolution (LTE) provided by the Third Generation Partnership Project (3GPP), Ultra Mobile Broadband (UMB) and Evolution Data Optimized (EV-DO) provided by the Third Generation Partnership Project 2 (3GPP2), 802.11 provided the Institute of Electrical and Electronics Engineers (IEEE), etc.

A fifth generation mobile standard, referred to herein as “5G,” “5G New Radio,” or “5G NR,” calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current LTE standard. Furthermore, signaling efficiencies should be enhanced and latency should be substantially reduced compared to current standards.

In cellular networks, “macro cell” access points provide connectivity and coverage to a large number of users over a certain geographical area. A macro network deployment is carefully planned, designed, and implemented to offer good coverage over the geographical region. To provide higher data transfer speeds, greater numbers of connections, and better coverage, for example, additional “small cell,” typically low-power, access points have recently begun to be deployed to supplement conventional macro networks. Small cell access points may also provide incremental capacity growth, richer user experience, and so on. Small cell operations for LTE and 5G networks, for example, have been extended into the unlicensed frequency spectrum, such as the Unlicensed National Information Infrastructure (U-NII) band used by Wireless Local Area Network (WLAN) technologies. This extension of small cell LTE and 5G operations is designed to increase spectral efficiency and hence capacity of LTE/5G systems.

With the dense deployment of macro cell base stations and small cell base stations, especially where such base stations operate on the same or similar frequencies, interference, especially at UEs within the cell range extension (CRE) area at the outer limits of a base station's coverage area, has become a significant problem.

### SUMMARY

The following presents a simplified summary relating to one or more aspects disclosed herein. As such, the following summary should not be considered an extensive overview relating to all contemplated aspects, nor should the following summary be regarded to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method for performing reference signal measurements of interfering cells at a UE includes determining, by the UE, an interference vector for each of a plurality of reference signal measurement occasions of a first cell of a plurality of cells of an interfering cell set from which to measure a reference signal, selecting, by the UE, a first reference signal measurement occasion and a second reference signal measurement occasion, the first reference signal measurement occasion and the second reference signal measurement occasion having a same interference vector, receiving, by the UE, a first measurement gap corresponding to the first reference signal measurement occasion and a second measurement gap corresponding to the second reference signal measurement occasion, during the first measurement gap corresponding to the first reference signal measurement occasion, determining, by the UE, a gain setting for performing a measurement of the reference signal transmitted during the second reference signal measurement occasion, and, during the second measurement gap corresponding to the second reference signal measurement occasion, performing, by the UE, the measurement of the reference signal transmitted during the second reference signal measurement occasion using the determined gain setting.

In an aspect, a method for assisting a UE to perform reference signal measurements of interfering cells includes determining, by the location server, an interference vector for each of a plurality of reference signal measurement occasions of a first cell of a plurality of cells of an interfering cell set from which the UE can measure a reference signal, selecting, by the location server, a first reference signal measurement occasion and a second reference signal measurement occasion, the first reference signal measurement occasion and the second reference signal measurement occasion having a same interference vector, determining, by the location server, a first measurement gap corresponding to the first reference signal measurement occasion and a second measurement gap corresponding to the second reference signal measurement occasion, and sending, by the location server, assistance data to the UE to enable the UE to determine a gain setting for performing a measurement of the reference signal transmitted during the second reference signal measurement occasion and perform the measurement of the reference signal transmitted during the second reference signal measurement occasion using the determined gain setting.

In an aspect, an apparatus for performing reference signal measurements of interfering cells at a UE includes at least one processor of the UE configured to: determine an interference vector for each of a plurality of reference signal measurement occasions of a first cell of a plurality of cells of an interfering cell set from which to measure a reference signal, select a first reference signal measurement occasion and a second reference signal measurement occasion, the first reference signal measurement occasion and the second reference signal measurement occasion having a same interference vector, and receive a first measurement gap corresponding to the first reference signal measurement occasion and a second measurement gap corresponding to the second reference signal measurement occasion, and a transceiver of the UE configured to: determine, during the first measurement gap corresponding to the first reference signal measurement occasion, a gain setting for performing a measurement of the reference signal transmitted during the second reference signal measurement occasion. and perform, during the second measurement gap corresponding to the second reference signal measurement occasion, the measurement of the reference signal transmitted during the second reference signal measurement occasion using the determined gain setting.

In an aspect, an apparatus for assisting a UE to perform reference signal measurements of interfering cells includes at least one processor of a location server configured to: determine an interference vector for each of a plurality of reference signal measurement occasions of a first cell of a plurality of cells of an interfering cell set from which the UE can measure a reference signal, select a first reference signal measurement occasion and a second reference signal measurement occasion, the first reference signal measurement occasion and the second reference signal measurement occasion having a same interference vector, and determine a first measurement gap corresponding to the first reference signal measurement occasion and a second measurement gap corresponding to the second reference signal measurement occasion, and a communication device of the location server configured to: send assistance data to the UE to enable the UE to determine a gain setting for performing a measurement of the reference signal transmitted during the second reference signal measurement occasion and perform the measurement of the reference signal transmitted during the second reference signal measurement occasion using the determined gain setting.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an exemplary heterogeneous network according to at least one aspect of the disclosure.

FIG. 2 illustrates an example configuration of a Radio Access Network (RAN) and a portion of a core network that is based on an Evolved Packet System (EPS), or LTE, network according to at least one aspect of the disclosure.

FIG. 3 illustrates an example wireless communication system including a UE in communication with a macro cell base station and a small cell base station according to at least one aspect of the disclosure.

FIG. 4 illustrates an exemplary location server according to various aspects of the disclosure.

FIG. 5A illustrates an example measurement gap configuration according to an aspect of the disclosure.

FIG. 5B illustrates an exemplary system in which base stations in the interfering cell set utilize almost-blank subframes (ABS) subframes to reduce interference.

FIG. 6 illustrates an exemplary UE-side method for selecting measurement gaps in which to perform a gain state determination and a PRS measurement according to at least one aspect of the disclosure.

FIG. 7 illustrates an exemplary network-side method for selecting measurement gaps in which to perform a gain state determination and a PRS measurement according to at least one aspect of the disclosure.

FIG. 8 illustrates an exemplary method of a UE performing PRS measurements of interfering cells during measurement gaps according to at least one aspect of the disclosure.

FIG. 9 illustrates an exemplary method of a location server assisting a UE's performance of PRS measurements of interfering cells during measurement gaps according to at least one aspect of the disclosure

### DETAILED DESCRIPTION

Aspects of the disclosure are provided in the following description and related drawings directed to various examples provided for illustration purposes. Alternate aspects may be devised without departing from the scope of the disclosure. Additionally, well-known aspects of the disclosure may not be described in detail or may be omitted so as not to obscure more relevant details.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., Application Specific Integrated Circuits (ASICs)), by program instructions being executed by one or more processors, or by a combination of both. In addition, for each of the aspects described herein, the corresponding form of any such aspect may be implemented as, for example, “logic configured to” perform the described action.

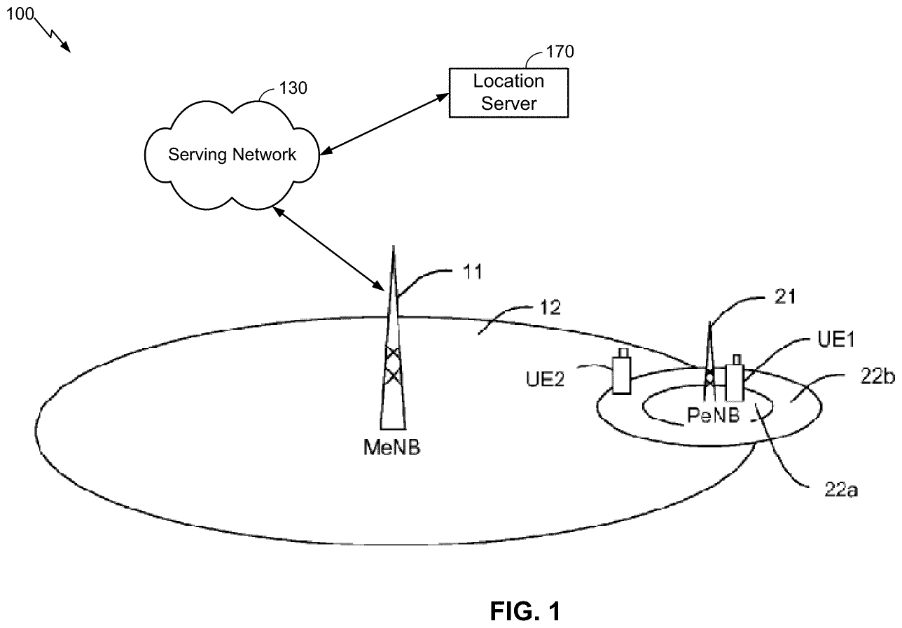

FIG. 1 illustrates an exemplary heterogeneous network 100 comprising a macro cell base station 11 (e.g., a macro eNodeB, or “MeNB”), a macro cell coverage area 12 served by the macro cell base station 11, a small cell base station 21 (e.g., a pico eNodeB, or “PeNB”), and a small cell coverage area served by the small cell base station 21. In an aspect, the small cell cell area is divided into a kernel cell coverage area 22a and an extended cell coverage area 22b, also referred to as a cell range extension (CRE) area. FIG. 1 further illustrates a first exemplary user equipment (UE1) located in the kernel cell coverage area 22a and a second user equipment (UE2) located in the extended cell coverage area 22b.

In the example of FIG. 1, the small cell base station 21 is deployed in conjunction with and to supplement the coverage of the macro cell base station 11. As used herein, small cells generally refer to a class of low-powered base stations that may include or be otherwise referred to as femto cells, pico cells, micro cells, etc. They may be deployed to provide improved signaling, incremental capacity growth, richer user experience, and so on. In the example of FIG. 1, the macro cell base station 11 and the small cell base station 21 are operating on the same frequency layer (i.e., in the same frequency range), hence the existence of the extended cell coverage area 22b, in which there is strong downlink interference from the macro cell base station 11 for UEs in that area, e.g., UE2.

A base station (e.g., macro cell base station 11, small cell base station 21) interacts with one or more UEs (e.g., UE1, UE2) via DownLink (DL) (e.g., a paging channel, a control channel, a broadcast channel, a forward traffic channel, etc.) and/or UpLink (UL) (e.g., a reverse traffic channel, a reverse control channel, an access channel, etc.) connections. In general, the DL corresponds to communication from a base station to a UE, while the UL corresponds to communication from a UE to a base station.

The macro cell base station 11 is configured to provide communication coverage within the macro cell coverage area 12, which may cover a few blocks within a neighborhood or several square miles in a rural environment. Meanwhile, the small cell base station 21 is configured to provide communication coverage within respective small cell coverage areas 22a and 22b. Note that although the base stations illustrated in FIG. 1 are referred to as eNodeBs, the disclosure is not so limited and they may be any type of access point. For example, they may instead be gNodeBs (5G NR access points).

For their wireless air interfaces, each base station (e.g., macro cell base station 11, small cell base station 21) may operate according to one of several radio access technologies (RATs) depending on the network in which it is deployed. These networks may include, for example, 5G millimeter wave (mmWave), Multiple Input, Multiple Output (MIMO), CDMA networks, TDMA networks, FDMA networks, OFDMA networks, Single-Carrier FDMA (SC-FDMA) networks, and so on. The terms “network” and “system” are often used interchangeably. A CDMA network may implement an RAT such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a RAT such as Global System for Mobile Communications (GSM). An OFDMA network may implement an RAT, such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). LTE is a release of UMTS that uses E-UTRA. UTRA, E-UTRA, GSM, UMTS, and LTE are described in documents from 3GPP. cdma2000 is described in documents from 3GPP2. These documents are publicly available.

The 5G NR mobile standard calls for higher data transfer speeds, greater numbers of connections, and better coverage, among other improvements. 5G NR radio access can be configured to utilize existing LTE infrastructure for mobility management (referred to as a non-standalone mode) or to operate stand-alone with a new multi-access 5G NextGen Core Network (NGCN). 5G is a unifying network concept that provides connectivity across diverse spectrum bands and radio access types. 5G expands spectrum usage to low-bands below 1 GHz, mid-bands between 1 GHz and 6 GHz, and high-bands generally above 24 GHz, (e.g., 5G mmWave). 5G also allows for access to licensed spectrum, shared spectrum, and unlicensed spectrum. As such, the discussion above with reference to FIG. 1, including systems using licensed spectrum, shared spectrum, and unlicensed spectrum is equally applicable to both 4G LTE and 5G NR.

As is further illustrated in FIG. 1, the macro cell base station 11 may communicate with a serving network 130, such as a Home Public Land Mobile Network (HPLMN) or a Visited Public Land Mobile Network (VPLMN), via a wired link or via a wireless link, while the small cell base station 21 may also similarly communicate with the serving network 130 via its own wired or wireless link (not shown). For example, the small cell base station 21 may communicate with the serving network 130 by way of an Internet Protocol (IP) connection, such as via a Digital Subscriber Line (DSL, e.g., including Asymmetric DSL (ADSL), High Data Rate DSL (HDSL), Very High Speed DSL (VDSL), etc.), a television cable carrying IP traffic, a Broadband over Power Line (BPL) connection, an Optical Fiber (OF) cable, a satellite link, or some other link.

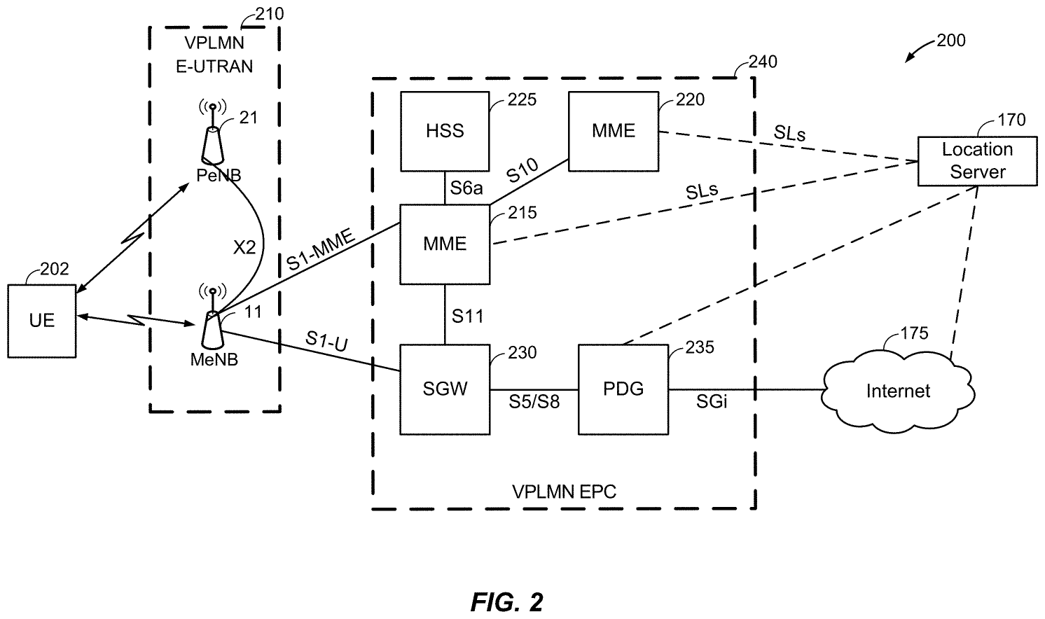

It will be appreciated that the macro cell base station 11 and/or the small cell base station 21 may be connected to the serving network 130 using any of a multitude of devices or methods. These connections may be referred to as the “backbone” or the “backhaul” of the network, and may, in some implementations, be used to manage and coordinate communications between the macro cell base station 11 and/or the small cell base station 21. In this way, as a UE (e.g., UE1, UE2) moves through such a mixed communication network environment that provides both macro cell and small cell coverage, the UE may be served in certain locations by macro cell base stations (e.g., macro cell base station 11), at other locations by small cell base stations (e.g., small cell base station 21), and, in some scenarios, by both macro cell and small cell base stations (e.g., UE2). As described with reference to FIG. 2, the various base stations may be referred to as the “RAN” (Radio Access Network) and the backhaul connections to the serving network 130 may be referred to as the “core network.”

To secure reliable transmission of the control channel and efficient transmission of the Physical Downlink Shared Channel (PDSCH) of the UE2 located in the extended cell area 22b, macro cell base stations (e.g., macro cell base station 11) and/or small cell base stations (e.g., small cell base station 21) are configured to transmit, during almost-blank subframes (ABS), only limited (or necessary) data, e.g., only signals such as Physical Broadcast Channel (PBCH) signals, Primary/Secondary Synchronization Signals (PSS/SSS), and/or cell-specific reference signals (CRS). As such, during ABS subframes, the UE2 will experience low interference from the macro cell base station 11 for the data channel, and conversely, high interference from macro cell base stations transmitting in non-ABS subframes. On the other hand, for UEs located sufficiently close to the center of the small cell coverage area (e.g., UE1), the interference from the macro cell base station 11 may be relatively small as compared with the signal from the small cell base station 21.

FIG. 2 illustrates an example configuration of a RAN 210 and a portion of a core network 240 of a communications system 200 based on an EPS or LTE network, in accordance with an aspect of the disclosure. Referring to FIG. 2, the RAN 210 in the EPS/LTE network includes base stations 11 and 21, which support LTE and/or wireless access, for example. In FIG. 2, the core network 240 includes a plurality of Mobility Management Entities (MMEs) 215 and 220, a Home Subscriber Server (HSS) 225, a Serving Gateway (SGW) 230, and a Packet Data Network Gateway (PDG) 235. Network interfaces between these components, the RAN 210, and the Internet 175 are illustrated in FIG. 2 and are defined in Table 2 (below) as follows:

TABLE 1
EPS/LTE Core Network Connection Definitions

| Network | |
|---|---|
| Interface | Description |
| S1-MME | Reference point for the control plane protocol between |
| | RAN 210 and MME 215. |
| S1-U | Reference point between RAN 210 and SGW 230 for the per |
| | bearer user plane tunneling and inter-eNodeB path switching |
| | during handover. |
| S5 | Provides user plane tunneling and tunnel management |
| | between SGW 230 and PDG 235. It is used for SGW |
| | relocation due to UE mobility and if the SGW 230 needs |
| | to connect to a non-collocated PDG for Packet Data |
| | Network (PDN) connectivity. |
| S6a | Enables transfer of subscription and authentication data for |
| | authenticating/authorizing user access to the evolved system |
| | (Authentication, Authorization, and Accounting (AAA) |
| | interface) between MME 215 and HSS 225. |
| S8 | Inter-PLMN reference point providing user and control plane |
| | between the SGW 230 in a VPLMN and the PDG 235 in a |
| | HPLMN. S8 is the inter-PLMN variant of S5. |
| S10 | Reference point between MMEs 215 and 220 for MME |
| | relocation and MME to MME information transfer. |
| S11 | Reference point between MME 215 and SGW 230. |
| SGi | Reference point between the PDG 235 and a packet data |
| | network, shown in FIG. 2 as the Internet 175. The packet |
| | data network may be an operator external public or private |
| | packet data network or an intra-operator packet data |
| | network (e.g., for provision of IP Multimedia Subsystem |
| | (IMS) services). |
| SLs | Interface between an MME and the location server 170 in the |
| | event that location server 170 is or contains an Enhanced |
| | Serving Mobile Location Center (E-SMLC) |
| X2 | Reference point between two different eNodeBs used for UE |
| | handoffs. |

A high-level description of the components shown in FIG. 2 will now be provided. However, these components are each well-known in the art from various 3GPP Technical Specifications (TSs), such as TS 23.401, and the description contained herein is not intended to be an exhaustive description of all functionalities performed by these components.

Referring to FIG. 2, the base stations 11 and 21 are configured to provide LTE and/or 5G NR radio access to one or more UEs 202 (which may correspond to, for example, UE1 and/or UE2) and to provide signaling and voice/data connectivity between any UE 202 and elements in core network 240, such as MME 215 and SGW 230. As described further herein, the base stations 11 and 21 may also be configured to broadcast positioning reference signals (PRS) to nearby UEs 202 to enable any UE 202 to make measurements of PRS timing differences between pairs of base stations and thereby enable a location estimate of the UE 202 to be obtained by the UE 202 itself or by a location server (e.g., location server 170) to which the timing difference measurements may be sent using Observed Time Difference of Arrival (OTDOA) positioning.

The term “location estimate” is used herein to refer to an estimate of a location for a UE 202, which may be geographic (e.g., may comprise a latitude, longitude, and possibly altitude) or civic (e.g., may comprise a street address, building designation, or precise point or area within or nearby to a building or street address, such as a particular entrance to a building, a particular room or suite in a building, or a landmark such as a town square). A location estimate may also be referred to as a “location,” a “position,” a “fix,” a “position fix,” a “location fix,” a “position estimate,” a “fix estimate,” or by some other term. The means of obtaining a location estimate may be referred to generically as “positioning,” “locating,” or “position fixing.” A particular solution for obtaining a location estimate may be referred to as a “location solution.” A particular method for obtaining a location estimate as part of a location solution may be referred to as a “position method” or as a “positioning method.”

Referring to FIG. 2, the MMEs 215 and 220 are configured to support network attachment of UE 202, mobility of UE 202, and bearer assignment to UE 202. MME functions include: Non-Access Stratum (NAS) signaling to UEs, NAS signaling security, mobility management for inter- and intra-technology handovers of UEs, PDG and SGW selection, and MME selection for UE handovers with MME change.

Referring to FIG. 2, the SGW 230 is the gateway that terminates the user plane interface toward the RAN 210. For each UE 202 attached to the core network 240 for an EPS-based system, at a given point of time, there may be a single SGW 230. The functions of the SGW 230 include: mobility anchor point, packet routing and forwarding, and transport level packet marking in the uplink and the downlink (e.g., setting the DiffSery Code Point (DSCP) based on a Quality of Service (QoS) Class Identifier (QCI) of an associated EPS bearer).

Referring to FIG. 2, the PDG 235 is the gateway that terminates the SGi user plane interface toward the PDN, e.g., the Internet 175. If a UE 202 is accessing multiple PDNs, there may be more than one PDG 235 for that UE 202. PDG 235 functions include: packet filtering (e.g., using deep packet inspection), UE IP address allocation, transport level packet marking in the uplink and downlink (e.g., setting the DSCP based on the QCI of an associated EPS bearer), accounting for inter operator charging, UL and DL bearer binding, UL and DL rate enforcement and service level rate enforcement, and UL bearer binding. The PDG 235 may provide PDN connectivity to both GSM/EDGE Radio Access Network (GERAN)/Universal Terrestrial Radio Access Network (UTRAN)-only UEs, and Enhanced UTRAN (E-UTRAN)-capable UEs using any of E-UTRAN, GERAN, or UTRAN. The PDG 235 may provide PDN connectivity to E-UTRAN-capable UEs using E-UTRAN only over the S5/S8 interface.

In FIG. 2, the location server 170 is shown as connected to one or more of the Internet 175, the PDG 235, MME 220, and MME 215. The connections to MME 215 and MME 220 are applicable when location server 170 is or contains an E-SMLC. The connections to the Internet 175 and/or to the PDG 235 are applicable when location server 170 is or contains an SLP, such a Home SLP (H-SLP), Emergency SLP (E-SLP), or Discovered SLP (D-SLP). Location server 170 may be used (i) to obtain a location for UE 202 (e.g., from signal measurements obtained and transferred by UE 202) and/or (ii) to provide assistance data to UE 202 to enable UE 202 to acquire and measure signals (e.g., signals from one or more of base stations 11 and 21) and, in some cases, compute a location from these signal measurements. Examples of assistance data can be orbital and timing data for Global Positioning System (GPS) or other Global Navigation Satellite System (GNSS) satellites when GPS or GNSS positioning is used, or information concerning downlink transmission from eNodeBs nearby to a UE 202 (e.g., any of base stations 11 and 21) when OTDOA is used for positioning.

To enable positioning in LTE and 5G and to facilitate positioning measurements by a UE (e.g., UE 202), base stations periodically transmit PRS. More specifically, PRS are transmitted in pre-defined positioning subframes grouped by several consecutive subframes, known as one positioning occasion. Positioning occasions occur periodically with a certain periodicity of N subframes, i.e., the time interval between two positioning occasions. In LTE, the standardized periods N are 160, 320, 640, and 1280 ms, and the number of consecutive subframes are 1, 2, 4, and 6.

To allow for detecting PRS from multiple sites and at a reasonable quality, positioning subframes have been designed as low-interference subframes (LIS). In general, data transmission is suppressed in positioning subframes. This means that the PDSCH is not transmitted to the UE 202 during the PRS subframes. Thus, in synchronous networks, PRS are ideally interfered with only by PRS from other cells having the same PRS pattern index and not by the data transmissions. However, in non-synchronous networks, such as those with small cell base stations operating on the same or similar frequencies widely deployed, interference can be a significant problem.

Since for OTDOA positioning PRS from multiple distinct locations need to be measured, the UE 202 receiver may have to deal with PRS that are much weaker than those received from the serving cell. Furthermore, without the approximate knowledge of when the measured signals are expected to arrive in time, or the exact PRS pattern, the UE 202 would need to perform a signal search within a large window, which would impact the time and accuracy of the measurements as well as the complexity of the UE 202. To facilitate UE 202 measurements, the network (e.g., location server 170, core network 240) transmits assistance data to the UE 202 that includes, among other things, reference cell information, a neighbor cell list containing physical cell identities (PCIs) of neighbor cells, the number of consecutive downlink subframes, PRS transmission bandwidth, frequency, and the like.

The UE 202 can perform inter-frequency measurements of PRS from cells operating on different frequencies in measurement gaps. In LTE, measurement gaps are configured (and re-configured as useful) by the network (e.g., location server 170, core network 240) to enable measurements on other LTE frequencies and/or other RATs (e.g., UTRAN, GSM, CDMA2000, etc.). The gap configuration is signaled to the UE 202 over the Resource Radio Control (RRC) protocol as part of the measurement configuration. Only one gap pattern can be configured at a time, and the network must re-configure the UE 202 to change the gap pattern. The same pattern is used for all types of configured measurements, e.g., inter-frequency neighbor cell measurements, inter-frequency positioning measurements, inter-RAT neighbor cell measurements, and inter-RAT positioning measurements.

Note, as is known in the art, a base station may have one or more (e.g., three) arrays of antennas, each corresponding to a geographic cellular coverage area, referred to as a “sector,” or “cell.” Thus, the term “cell,” “secondary cell,” “secondary cell eNodeB,” “SCell eNodeB,” etc., refers to a cell, or sector, of a base station. For simplicity, the present disclosure refers to a base station and the corresponding cell interchangeably.

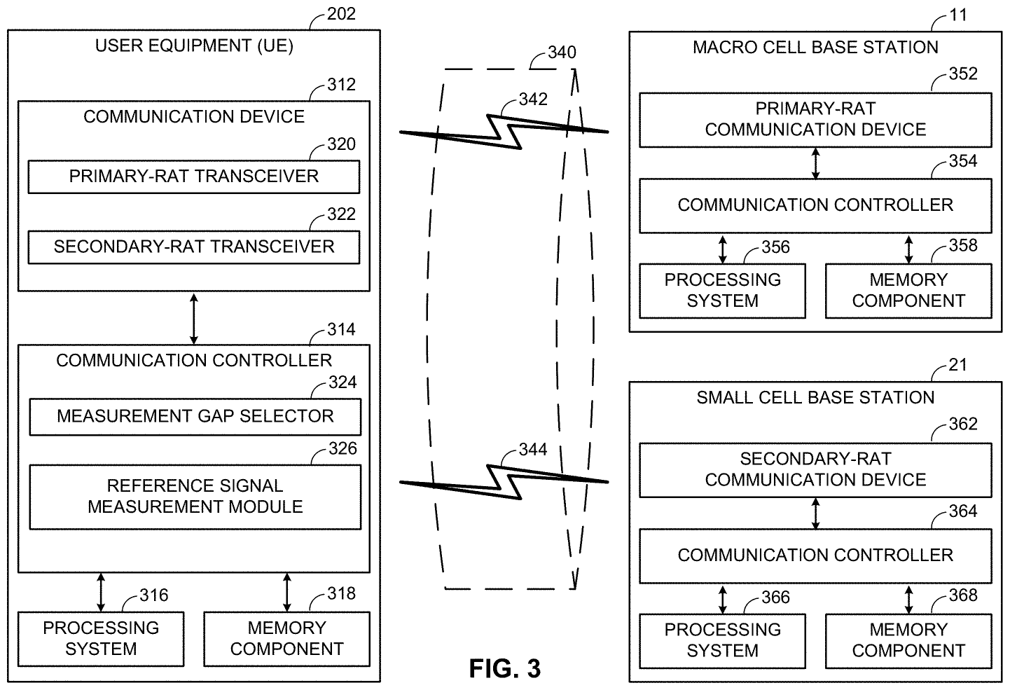

FIG. 3 illustrates an example wireless communication system including the UE 202 in communication with the macro cell base station 11 and the small cell base station 21 according to at least one aspect of the disclosure. In general, UEs may be any wireless communication device allowing a user to communicate over a communications network (e.g., a mobile phone, router, tablet computer, personal computer, entertainment device, Internet of Things (IOT)/Internet of Everything (IOE) capable device, in-vehicle communication device, etc.), and may be alternatively referred to in different RAT environments as an Access Terminal (AT), a User Device (UD), a Mobile Station (MS), a Subscriber Station (STA), etc. Similarly, a base station may operate according to one or several RATs in communicating with UEs depending on the network in which the base station is deployed, and may be alternatively referred to as an Access Point (AP), a Network Node, a NodeB, an evolved NodeB (eNB), a gNodeN (gNB), etc.

In the example of FIG. 3, the UE 202 may at times be in communication with the macro cell base station 11 and at other times with the small cell base station 21. The UE 202 and the base stations 11 and 21 each generally include a wireless communication device (represented by the communication devices 312, 352, and 362) for communicating with other network nodes via at least one designated RAT. The communication devices 312, 352, and 362 may be variously configured for transmitting and encoding signals (e.g., messages, indications, information, and so on), and, conversely, for receiving and decoding signals (e.g., messages, indications, information, pilots, and so on) in accordance with the designated RAT. The UE 202 and the base stations 11 and 21 may also each generally include a communication controller (represented by the communication controllers 314, 354, and 364) for controlling operation of their respective communication devices 312, 352, and 362 (e.g., directing, modifying, enabling, disabling, etc.). The communication controllers 314, 354, and 364 may operate at the direction of or otherwise in conjunction with respective host system functionality (illustrated as the processing systems 316, 356, and 366 and the memory components 318, 358, and 368). In some designs, the communication controllers 314, 354, and 364 may be partly or wholly subsumed by the respective host system functionality. The processing systems 316, 356, and 366 may be general purpose processors, multi-core processors, ASICs, field programmable gate arrays (FPGAs), or the like.

Turning to the illustrated communication in more detail, the UE 202 may transmit and/or receive messages via a wireless link 342 with the macro cell base station 11. The UE 202 may also transmit and/or receive messages via a wireless link 344 with the small cell base station 21. The messages may include information related to various types of communication (e.g., voice, data, multimedia services, associated control signaling, etc.). In some cases, the macro cell base station 11 may operate via the wireless link 342 in accordance with a first (primary) RAT (e.g., LTE) and be accordingly referred to herein as a primary-RAT base station with associated primary-RAT components. Similarly, the small cell base station 21 may operate via the wireless link 344 in accordance with a second (secondary) RAT (e.g., LTE in Unlicensed Spectrum, or “LTE-U”) and be referred to herein as a secondary-RAT base station with associated secondary-RAT components. Alternatively, the base stations 11 and 21 may operate in accordance with the same RAT.

The wireless links 342 and 344 may operate over a common communication medium of interest, shown by way of example in FIG. 3 as the medium 340, which may be shared with still other communication systems and signaling schemes. A medium of this type may be composed of one or more frequency, time, and/or space communication resources (e.g., encompassing one or more channels across one or more carriers) associated with communication between one or more transmitter/receiver pairs. Because the wireless links 342 and 344 may operate over a common communication medium, even where the base stations 11 and 21 operate in accordance with different RATs, transmissions from the base stations 11 and 21 may still interfere with each other where such transmissions utilize the same or similar frequency.

As a particular example, the medium 340 may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by Wireless Local Area Network (WLAN) technologies, most notably IEEE 802.11x WLAN technologies generally referred to as “Wi-Fi.” Example systems of this type include different variants of Code Division Multiple Access (CDMA) systems, Time Division Multiple Access (TDMA) systems, Frequency Division Multiple Access (FDMA) systems, Orthogonal FDMA (OFDMA) systems, Single-Carrier FDMA (SC-FDMA) systems, and so on.

In the example of FIG. 3, the communication device 312 of the UE 202 includes a primary-RAT transceiver 320 configured to operate in accordance with the primary RAT of the macro cell base station 11 and a co-located secondary-RAT transceiver 322 configured to operate in accordance with the secondary RAT of the small cell base station 21. As an example, the primary-RAT transceiver 320 may operate in accordance with LTE-U technology and the secondary-RAT transceiver 322 may operate in accordance with LTE technology. As used herein, a “transceiver” may include a transmitter circuit, a receiver circuit, or a combination thereof, but need not provide both transmit and receive functionalities in all designs. For example, a low functionality receiver circuit may be employed in some designs to reduce costs when providing full communication is not necessary (e.g., a receiver chip or similar circuitry simply providing low-level sniffing). Further, as used herein, the term “co-located” (e.g., radios, access points, transceivers, etc.) may refer to one of various arrangements. For example, components that are in the same housing; components that are hosted by the same processor; components that are within a defined distance of one another; and/or components that are connected via an interface (e.g., an Ethernet switch) where the interface meets the latency requirements of any inter-component communication (e.g., messaging).

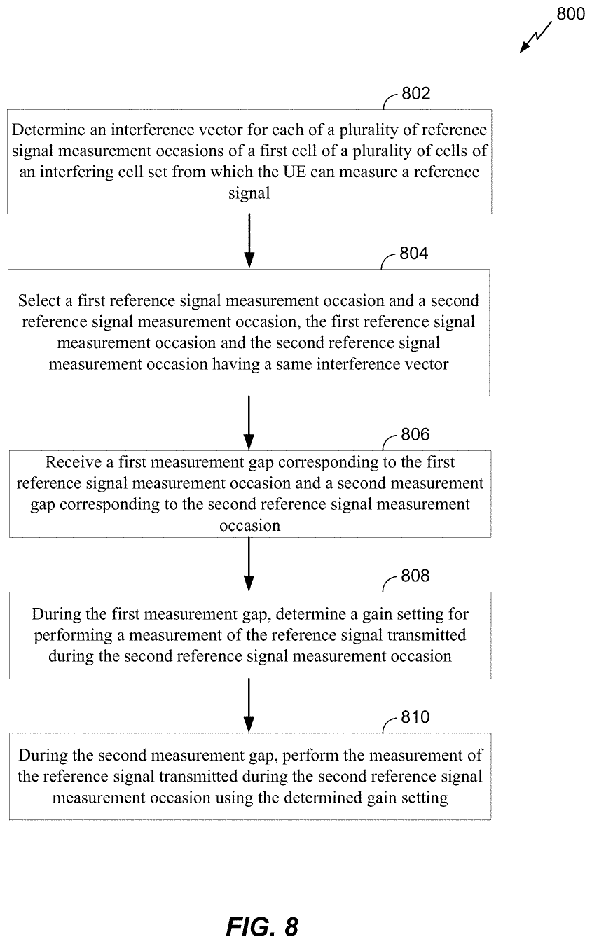

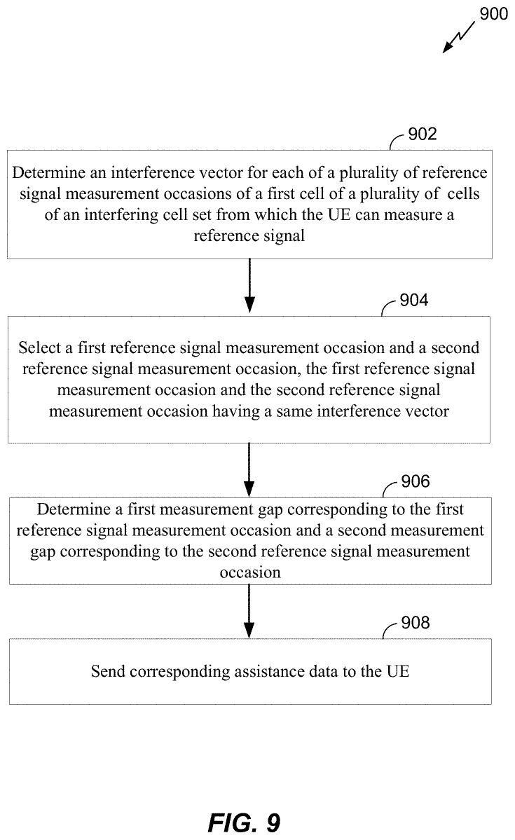

As will be discussed in more detail below with reference to FIGS. 8 and 9, the communication controller 314 of the UE 202 may include a measurement gap selector 324 and a reference signal measurement module 326, which may operate in conjunction with the primary-RAT transceiver 320 and/or the secondary-RAT transceiver 322 to manage operation on the medium 340. The measurement gap selector 324 and the reference signal measurement module 326 may be software modules stored in memory and executable by a processor to cause the processor to perform the UE operations described herein, or may be hardware circuits that perform the UE operations described herein, or may be a combination of hardware and software (e.g., firmware).

For example, where the UE 202 is configured to perform reference signal measurements of interfering cells during measurement gaps, execution of the measurement gap selector 324 and/or the reference signal measurement module 326 may cause the communication controller 314 or processing system 316 to determine an interference vector for each of a plurality of reference signal measurement occasions of a first cell of a plurality of cells of an interfering cell set from which to measure a reference signal, select a first reference signal measurement occasion and a second reference signal measurement occasion, the first reference signal measurement occasion and the second reference signal measurement occasion having a same interference vector, and receive a first measurement gap corresponding to the first reference signal measurement occasion and a second measurement gap corresponding to the second reference signal measurement occasion. Execution of the measurement gap selector 324 and/or the reference signal measurement module 326 may cause communication device 312 and/or the communication controller 314 to determine, during the first measurement gap corresponding to the first reference signal measurement occasion, a gain setting for performing a measurement of the reference signal transmitted during the second reference signal measurement occasion, and perform, during the second measurement gap corresponding to the second reference signal measurement occasion, the measurement of the reference signal transmitted during the second reference signal measurement occasion using the determined gain setting. In some examples, the interfering cell set comprises a plurality of cells utilizing the same frequency and within communication range of the UE 202.

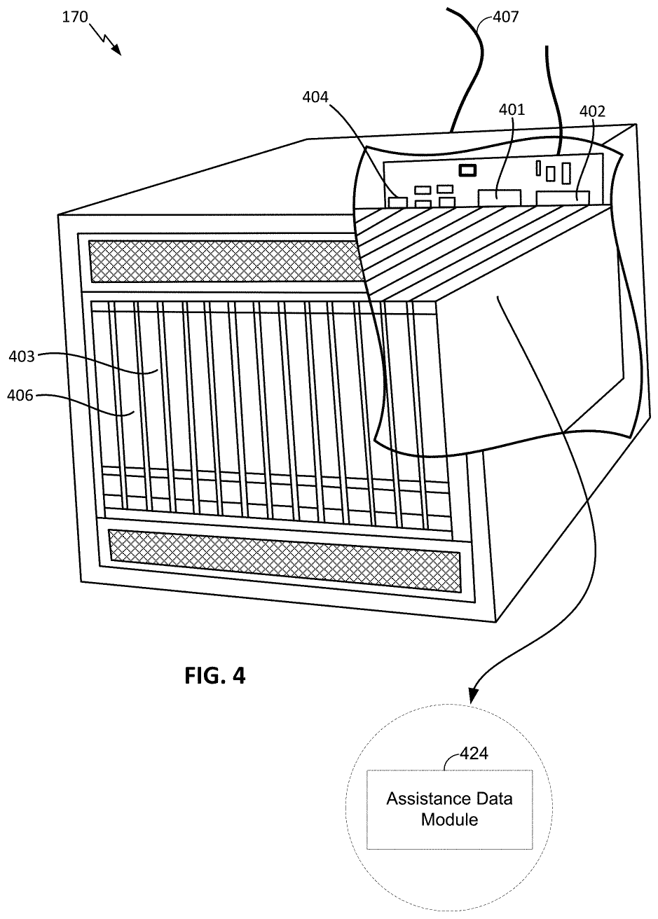

Various aspects of the disclosure may be implemented on any of a variety of commercially available server devices, such as location server 170 illustrated in FIG. 4. In FIG. 4, the location server 170 includes a processing system 401 coupled to volatile memory 402 and a large capacity nonvolatile memory 403, such as a disk drive. The location server 170 may also include a floppy disc drive, compact disc (CD), or digital video disc (DVD) drive 406 coupled to the processing system 401. The location server 170 may also include a communication device 404, such as one or more network access ports, coupled to the processing system 401 for establishing data connections with a network 407, such as a local area network coupled to other broadcast system computers and servers or to the Internet 175.

In an aspect, the volatile memory 402 or the nonvolatile memory 403 may include an assistance data module 424 that may perform, or cause the performance of, the location server operations for assisting a UE to select measurement gaps for performing PRS measurements as described herein. In an aspect, the assistance data module 424 may be a software module storing instructions that, when executed by the processing system 401, cause the location server 170 to perform the location server operations described herein. In another aspect, the assistance data module 424 may be a circuit that is part of or coupled to the processing system 401 that performs the location server operations described herein. In yet another aspect, the assistance data module 424 may be a combination of hardware and software, such as a firmware component of the location server 170.

For example, where the location server 170 is configured to assist a UE's performance of reference signal measurements of interfering cells during measurement gaps, execution of the assistance data module 424 may cause the processor 401) to determine an interference vector for each of a plurality of reference signal measurement occasions of a first cell of a plurality of cells of an interfering cell set from which the UE can measure a reference signal, select a first reference signal measurement occasion and a second reference signal measurement occasion, the first reference signal measurement occasion and the second reference signal measurement occasion having a same interference vector, and determine a first measurement gap corresponding to the first reference signal measurement occasion and a second measurement gap corresponding to the second reference signal measurement occasion. Execution of the assistance data module 424 may cause the communication device 404 to send assistance data to the UE to enable the UE to determine a gain setting for performing a measurement of the reference signal transmitted during the second reference signal measurement occasion and perform the measurement of the reference signal transmitted during the second reference signal measurement occasion using the determined gain setting.

As noted above, to provide higher data transfer speeds, greater numbers of connections (e.g., users), and better coverage, for example, additional “small cell,” typically low-power, base station have recently begun to be deployed to supplement conventional macro networks. As used herein, small cells generally refer to a class of low-powered base stations that may include or be otherwise referred to as femto cells, pico cells, micro cells, etc. With the dense deployment of macro cell base stations and small cell base stations, especially where such base stations operate on the same or similar frequencies, interference, especially at UEs within the cell range extension (CRE) area at the outer limits of a base station's coverage area, has become a significant problem.

For example, as discussed above with reference to FIG. 1, the macro cell base station 11 and the small cell base station 21 may be operating on the same frequency layer, thereby creating the extended cell coverage area 22b in which there is strong downlink interference from the macro cell base station 11 for UEs in that area, e.g., UE2. The following types of interference can occur in such a scenario. First, the PRS of base station A (either macro cell base station 11 or small cell base station 21) may interfere with the PRS of base station B (the other of macro cell base station 11 or small cell base station 21). This is handled using PRS muting, as is known in the art. Second, the PRS of either base station A or B may cause interference with the CRS of cell A or B (e.g., a cell of macro cell base station 11 or small cell base station 21). This has been addressed using information element (IE) changes. Third, the scheduling of downlink data traffic in cell A (e.g., a cell of macro cell base station 11 or small cell base station 21) may interfere with the PRS of cell B (e.g., a different cell of macro cell base station 11 or small cell base station 21). Currently, the third type of interference can be handled with Further Enhanced Inter-Cell Coordination Interference Cancellation (FEICIC) support. However, FEICIC has the disadvantage that it uses additional hardware, processing, and ukernel support at the UE.

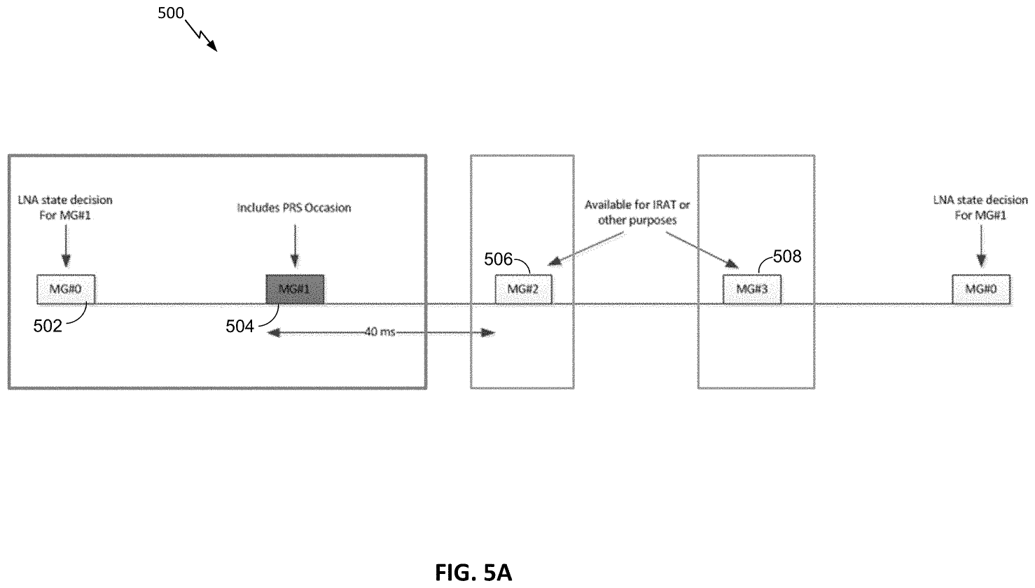

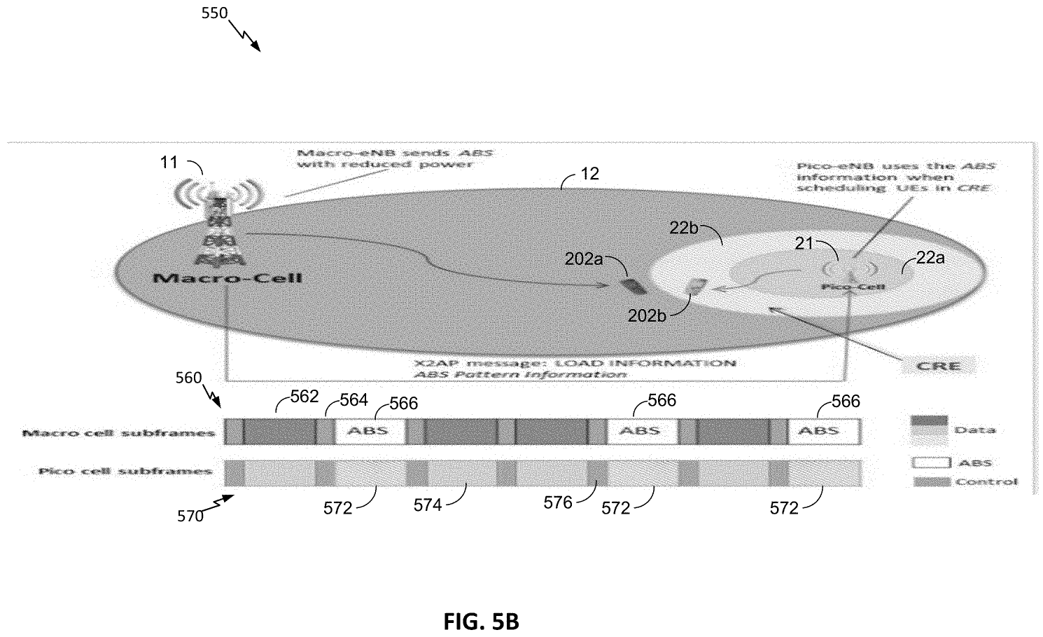

FIG. 5A illustrates an example measurement gap (MG) configuration 500 according to an aspect of the disclosure. In the example of FIG. 5, there is a 6 ms measurement gap created every 40 ms. Each PRS is measured in two occasions, or during two measurement gaps 502 and 504. During the first measurement gap 502, the UE 202 measures the gain of the channel to determine the gain setting (referred to as automatic gain control, or “AGC”) for the subsequent PRS measurement. During the second measurement gap 504, the UE 202 performs the actual PRS measurement of a PRS occasion occurring during the second measurement gap 504 using the computed gain settings from the first measurement gap 502. The UE 202 uses the two measurement gaps 502 and 504 to perform a PRS measurement because a single measurement gap may not be long enough for the UE 202 to tune to the channel, perform AGC, and measure the PRS occasion. Subsequent measurement gaps, e.g., measurement gaps 506 and 508, may be used for other operations, such as inter-RAT operations.

A UE indicates whether or not it supports FEICIC in the initial RRC connection message. In regions where deployments are such that cells cause interference with each other, this can lead to PRS measurement being incorrectly or differently estimated for UEs that do not support FEICIC. For example, in a first scenario (1), a PRS measurement during a PRS occasions/measurement gap when interference from another cell is active would lead to the UE over-estimating the received power/signal strength of the channel. In a second scenario (2), for PRS occasions/measurement gaps when the other cells are not interfering, the UE would measure a lower signal strength compared to the first scenario.

In cases when the first measurement/occasion (i.e., for gain state determination) and the second measurement/occasion (i.e., for the actual measurement) fall under two different scenarios ((1) and (2) above), PRS detectability fails. For example, in a first case, if the first measurement gap (the gain state occasion) occurs under scenario (1) above, where the interfering cells on the same frequency layer are actively transmitting, the signal strength of the PRS signal would be over-estimated, and using the determined gain settings for the second measurement gap would lead to under-saturation in the second measurement gap. In a second case, where the first measurement gap (the gain state occasion) occurs under scenario (2) above, where the interfering cells are not actively transmitting and hence the actual PRS signal strength would be estimated correctly, using the determined gain settings in the second measurement gap would lead to over-estimation in the second measurement gap. Thus, if the level of interference is different between the two measurement gaps, PRS detectability can fail. To overcome this, it can be helpful to select two measurement gaps with similar interference levels.

Cells use ABS to coordinate among the interfering set of cells (i.e., the set of cells in a given geographic area operating on the same frequency layer and identified by the UE as potentially interfering with each other) to indicate the subframes during which they will not schedule their UEs for data reception. Each cell coordinates and shares the ABS information over the X2 interface. Thus, in any subframe, in one interfering cell set, only one cell at a time schedules downlink transmissions to its UEs and the rest have an ABS in that subframe. The network (e.g., location server 170) shares this ABS scheduling information with UEs in the coverage area of the interfering set of cells.

This is illustrated in greater detail in FIG. 5B. FIG. 5B illustrates an exemplary system 550 in which base stations in the interfering cell set utilize ABS subframes to reduce interference. As shown in FIG. 5B, a UE 202a is served by the macro cell base station 11 and a UE 202b is located in the extended cell coverage area 22b, and may be served at times by either the macro cell base station 11 or the small cell base station 21. The macro cell base station 11 and the small cell base station 21 may communicate load information and ABS pattern information over the X2 interface.

In the example of FIG. 5B, the macro cell base station 11 transmits a sequence of downlink subframes 560 comprising data subframes 562, control subframes 564, and ABS subframes 566 (some of which are labeled with reference numbers in FIG. 5B). The small cell base station 21 transmits a sequence of downlink subframes 570 comprising PRS subframes 572 (also referred to as PRS measurement occasions), data subframes 574, and control subframes 576 (some of which are labeled with reference numbers in FIG. 5B). Although not illustrated in FIG. 5B, the small cell base station 21 may also utilize ABS subframes. In addition, other base stations (not shown in FIG. 5B), whether macro cell base stations or small cell base stations, may have different ABS configurations. Further, although FIG. 5B illustrates a complete overlap between the ABS subframes 566 and the PRS subframes 572, this may not always, or ever, be the case.

The techniques of the present disclosure use the ABS information shared with the UE to determine which cells will be scheduling downlink data traffic in which subframes. In that way, when a UE measures PRS of a certain cell belonging to the interfering cell set, it can use the ABS information to measure both the first occasion (the gain state determination) and the second occasion (the actual measurement) either in (1) subframes when only that cell is active and all other cells from the interfering set transmit ABS, or (2) subframes under the same ABS configuration such that that gain settings from the first occasion can still be used for the second occasion with no loss of PRS detectability. Using this information, the UE can determine an intelligent measurement gap configuration and selection of measurement gaps for different PRS occasions instead of having to use two successive measurement gaps for the same cell measurement.

For example, for a cell whose PRS the UE wishes to measure, the UE may determine the gain state in a first measurement gap during which only that cell is transmitting and the other interfering cells transmit ABS, and then, rather than simply take the actual PRS measurement in the next measurement gap, wait for the next measurement gap that that cell will be transmitting PRS and the other interfering cells will transmit ABS. In that way, the gain setting determined during the first measurement gap will be applicable to the second measurement gap.

In addition, since the UE may not need to measure the PRS of every cell in the interfering cell set, the UE can choose to measure cells whose PRS align with relatively closely spaced measurement gaps (e.g., PRS that the UE can measure every four measurement gaps).

In an aspect, the solution of the present disclosure can use UE and server coordination. On the UE side, at the time of capability sharing with the location server (e.g., location server 170), the UE would share the ABS information of the cells from the set of interfering cells. Additional IEs could be added in order for the UE to share this information. On the location server side, the location server can use the ABS information from the UE to optimize the assistance data for the UE. For example, PRS neighbor cells in the assistance data and their measurement configurations (e.g., I_{PRS}, PRS_{OFFSET}, N_{PRS},) can be intelligently selected to ensure that PRS occasions from the same cell do not suffer from different levels of interference. Additionally, this can be requested selectively or explicitly by the UE using a new IE element.

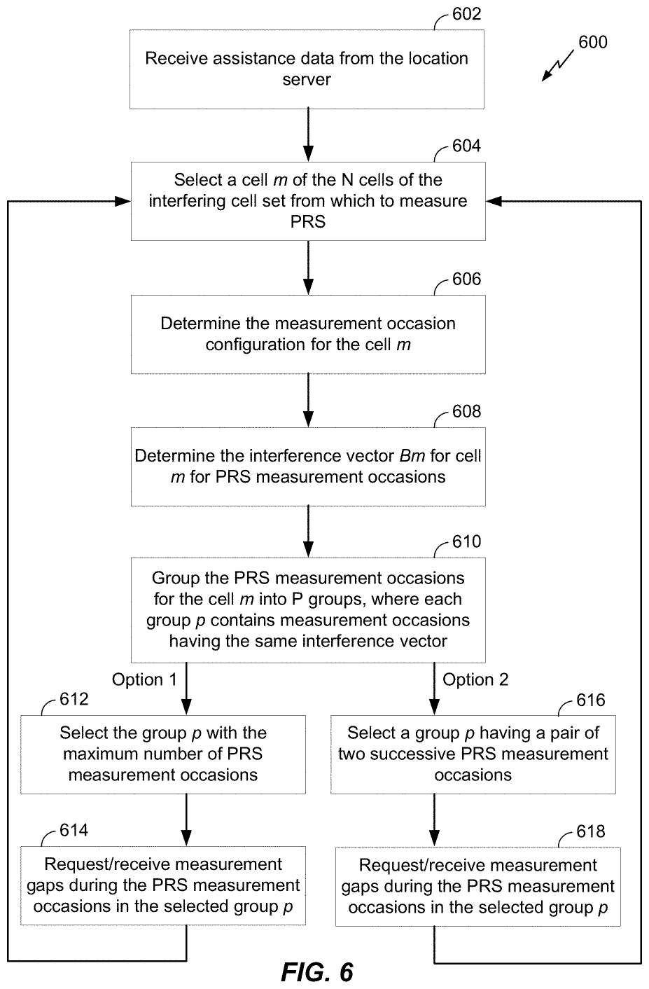

FIG. 6 illustrates an exemplary UE-side method 600 for selecting measurement gaps in which to perform a gain state determination and a PRS measurement according to at least one aspect of the disclosure. The method 600 may be performed by a UE (e.g., UE 202). In the example of FIG. 6, a plurality of N cells (e.g., cell₁, cell₂, . . . cell_{N}) make up the N cells of the interfering cell set. The N cells may include one or more cells of one or more macro cell base stations (e.g., macro cell base station 11) and/or one or more cells of one or more small cell base stations (e.g., small cell base station 21).

At 602, the UE receives assistance data from the location server (e.g., location server 170). As is known in the art, the assistance data may include identifiers of the N cells of the interfering cell set and the PRS configuration for those cells. At 604, the UE selects a cell m, which may be referred to as a first cell, of the N cells of the interfering cell set from which to measure PRS. At 606, the UE determines the measurement occasion configuration of the cell m. That is, for every cell m on which a reference signal is to be measured, the UE determines the measurement occasions where the reference signal for cell m will be present. At 608, the UE determines the interference vectors Bₘ for the cell m for PRS measurement occasions (i.e., all occasions that need to be measured, as indicated in the assistance data). More specifically, for each PRS measurement occasion of the occasions for the cell m, the interference vector is defined as Bₘ={b₁, b₂, . . . b_{N}}, where bₙ indicates whether cell n (which may be referred to as a remaining cell of the set, i.e., a cell other than cell m) of the N cells of the interfering cell set is or is not interfering during that PRS measurement occasion. For example, a value of 0 (i.e., bₙ=0) may indicate that cell bₙ does not interfere during the PRS measurement occasion, and a value of 1 (i.e., bₙ=1) may indicate that cell bₙ does interfere during the PRS measurement occasion.

In an aspect, the interference vector for each of the plurality of reference signal measurement occasions comprises a set of values, such as the aforementioned 0s and 1s indicating a cell's noninterference or interference during the PRS measurement occasion as one example, indicating whether remaining cells of the interfering cell set other than the first cell do or do not interfere with the each reference signal measurement occasion of the plurality of reference signal measurement occasions. Whether a cell “interferes” with a reference signal measurement occasion can be, in one example, based on whether the cell schedules data transmissions (for example PDSCH transmissions or Physical Downlink Control Channel (PDCCH) transmissions) in one or more subframes during the reference signal measurement occasion. Hence, if a cell does not schedule a data transmission in one or more subframes of the reference signal measurement occasion, it can be said that such a cell does not interfere with the reference signal measurement occasion. Examples of such subframes during which remaining cells do not schedule data transmissions can include ABS. The UE can, in one implementation, receive, from the remaining cell(s), information identifying the one or more subframes during which the remaining cell(s) does/do not schedule data transmissions.

At 610, the UE groups the PRS measurement occasions for the cell m into P groups, where each group p contains occasions with the same interference vector. After all the PRS measurement occasions have been divided into P groups, all of the PRS measurement occasions in each group will have the same level of interference. Consider an example. Given four cells A to D in the interfering cell set, the interference vectors for cell m=A may be {0,0,1} for a first PRS measurement occasion (indicating that cell B does not interfere and cells C and D do interfere during the first PRS occasion), {1,0,1} for a second PRS measurement occasion, {0,0,1} for a third PRS measurement occasion, and {1,1,0} for a fourth PRS measurement occasion. Thus, at 610, the UE would group the first and third PRS measurement occasions together, as these occasions have the same interference vectors, and the second and fourth PRS measurement occasions would be their own groups, resulting in P=3 groups.

From here, the UE may perform one of two options. As a first option, at 612, the UE selects the group p of PRS measurement occasions that has the maximum number of PRS measurement occasions. In the previous example, this would be the group containing the first and third PRS measurement occasions (having the interference vectors {0,0,1}), as this group has two PRS measurement occasions and the other two groups only have one PRS measurement occasion each. At 614, the UE requests, or the network (e.g., location server 170) provides, measurement gaps during the PRS measurement occasions in the selected group p. The UE can then measure the selected PRS measurement occasions during the requested/provided measurement gaps. In the above example, the UE would request, or the network provide, measurement gaps for the first and third PRS measurement occasions, and the UE would measure these occasions. The method 600 then returns to 604 and the UE selects another cell m from the interfering cell set.

As a second option, at 616, rather than selecting the group p of PRS measurement occasions that has the maximum number of PRS measurement occasions, the UE selects a first group p having a pair of two successive PRS measurement occasions. The UE repeats 616 until it has selected all, or a sufficient number of, groups p that have pairs of two successive PRS measurement occasions. At 618, the UE requests, or the network (e.g., location server 170) provides, measurement gaps during the pair of PRS measurement occasions in the selected group p. The UE can then measure the selected PRS measurement occasions during the requested/provided measurement gaps. More specifically, the UE measures PRS measurement occasions of the pair of measurement occasions of the first group p, then the PRS measurement occasions of the pair of measurement occasions of the second group p, and so on. For each pair, the first measurement occasion is used to determine the gain setting and the second measurement occasion is used for the actual PRS measurement. The UE may repeat operation 616 and 618 until a sufficient number of PRS occasions have been measured for cell m. The method 600 then returns to 604 and the UE selects another cell m from the interfering cell set.

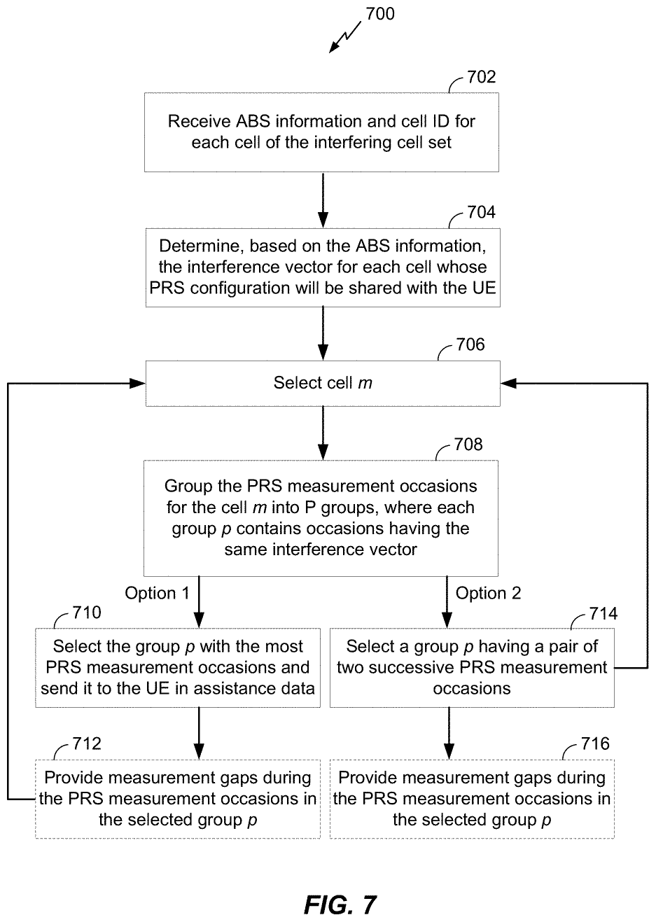

FIG. 7 illustrates an exemplary network-side method 700 for selecting measurement gaps in which to perform a gain state determination and a PRS measurement according to at least one aspect of the disclosure. The method 700 may be performed by a location server (e.g., location server 170). As in the example of FIG. 6, in the example of FIG. 7, a plurality of N cells (e.g., cell₁, cell₂, . . . cell_{N}) make up the N cells of the interfering cell set. The N cells may include one or more cells of one or more macro cell base stations (e.g., macro cell base station 11) and/or one or more cells of one or more small cell base stations (e.g., small cell base station 21).

At 702, the location server receives, from a UE (e.g., UE 202), the ABS information (e.g., the ABS configuration) and cell ID for each cell in the interfering cell set. At 704, the location server determines, based on the ABS information, the interference vector Bₘ for each cell m in the interfering cell set whose PRS configuration will be shared with the UE. As discussed above with reference to FIG. 6, for each PRS measurement occasion of the occasions for the cell m, the interference vector is defined as Bₘ={b₁, b₂, . . . b_{N}}, where bₙ indicates whether cell n of the N cells of the interfering cell set is or is not interfering during that PRS measurement occasion.

At 706, the location server selects a cell m from the set of cells whose PRS configuration will be shared with the UE. At 708, the location server groups the PRS measurement occasions for the cell m into P groups, where each group p contains PRS measurement occasions with the same interference vector, as the UE does at 610 of FIG. 6. After all the PRS measurement occasions have been divided into P groups, all of the PRS measurement occasions in each group will have the same level of interference. Consider an example. Given four cells A to D in the interfering cell set, the interference vectors for cell m=A may be {1,0,0} for a first PRS measurement occasion (indicating that cell B interferes and cells C and D do not interfere during the first PRS occasion), {1,0,1} for a second PRS measurement occasion, {1,0,0} for a third PRS measurement occasion, and {0,1,1} for a fourth PRS measurement occasion. Thus, at 708, the location server would group the first and third PRS measurement occasions together, as these occasions have the same interference vectors, and the second and fourth PRS measurement occasions would be their own groups, resulting in P=3 groups.

In an aspect, the interference vector for each of the plurality of reference signal measurement occasions comprises a set of values, such as the aforementioned 0s and 1s indicating a cell's noninterference or interference during the PRS measurement occasion as one example, indicating whether remaining cells of the interfering cell set other than the first cell do or do not interfere with the each reference signal measurement occasion of the plurality of reference signal measurement occasions. Whether a cell “interferes” with a reference signal measurement occasion can be, in one example, based on whether the cell schedules data transmissions (for example PDSCH transmissions or PDCCH transmissions) in one or more subframes during the reference signal measurement occasion. Hence, if a cell does not schedule a data transmission in one or more subframes of the reference signal measurement occasion, it can be said that such a cell does not interfere with the reference signal measurement occasion. Examples of such subframes during which remaining cells do not schedule data transmissions can include ABS. The location server can, in one implementation, receive, from the UE, information identifying the one or more subframes during which the remaining cell(s) does/do not schedule data transmissions. Alternatively, the location server can receive this information from the cells themselves.

From here, like the UE in FIG. 6, the location server may perform one of two options. At 710, as a first option, the location server selects the group p with the maximum number of PRS measurement occasions and sends it to the UE in the assistance data. In the previous example, this would be the group containing the first and third PRS measurement occasions (having the interference vectors {1,0,0}), as this group has two PRS measurement occasions and the other two groups only have one PRS measurement occasion each. As noted above, PRS measurements occur in pairs, where the UE first determines the gain setting during a first measurement occasion and then performs the actual time of arrival (TOA) measurement during a second measurement occasion using the determined gain setting. Thus, when the UE receives the group p, it pairs the measurement occasions in the group p and then uses the first occasion of a pair to determine the gain state and the second occasion of the pair to perform the measurement. At 712, the location server can provide measurement gaps during the PRS measurement occasions in the selected group p. The UE can then measure the selected PRS measurement occasions during the provided measurement gaps. Alternatively, the location server can wait until the UE requests measurement gaps. In the above example, the location server would optionally provide, or the UE would request, measurement gaps for the first and third PRS measurement occasions, and the UE would measure these occasions. The method 700 then returns to 706 and the location server selects another cell m from the interfering cell set.

As a second option, at 714, rather than selecting the group p of PRS measurement occasions that has the maximum number of PRS measurement occasions, the location server selects a first group p having a pair of two successive PRS measurement occasions. The location server repeats 714 until it has selected all, or a sufficient number of, groups p that have pairs of two successive PRS measurement occasions. Again, as noted above, PRS measurements occur in pairs. Thus, when the UE receives the groups p, it selects the pair of successive measurement occasions in the groups p and then uses the first occasion of a pair to determine the gain state and the second occasion of the pair to perform the measurement. More specifically, the UE measures PRS measurement occasions of the pair of measurement occasions of a first group p, then the PRS measurement occasions of the pair of measurement occasions of a second group p, and so on. At 716, the location server optionally provides, or the UE requests, measurement gaps during the pair of PRS measurement occasions in the selected group p. The UE can then measure the selected PRS measurement occasions during the requested/provided measurement gaps. The location server may repeat operations 714 and 716 until a sufficient number of PRS occasions have been selected for cell m. The method 700 then returns to 706 and the location server selects another cell m from the interfering cell set.

Although FIGS. 6 and 7 have been described in terms of PRS, as will be appreciated, the techniques described herein are applicable to other types of reference signals, such as CRS and the like.

FIG. 8 illustrates an exemplary method 800 of a UE (e.g., UE 202) performing reference signal measurements of interfering cells during measurement gaps according to at least one aspect of the disclosure. At 802, the UE (e.g., processing system 316) determines an interference vector for each of a plurality of reference signal measurement occasions of a first cell of a plurality of cells of an interfering cell set from which to measure a reference signal, as at 608 of FIG. 6. It is understood that, for example, the plurality of reference signal measurement occasions of the first cell may include two or more occasions, and hence, if two or more interference vectors are determined, each interference vector corresponding to a measurement occasion, such two or more interference vectors can comprise an interference vector for each of the plurality of reference signal measurement occasions of the first cell even if additional reference signal measurement occasions for the first cell exist. In an aspect, means for performing the functionality of block 802 can, but not necessarily, include, for example, communication device 312, communication controller 314, processing system 316, and/or memory component 318 with reference to FIG. 3.

At 804, the UE (e.g., processing system 316) selects a first reference signal measurement occasion and a second reference signal measurement occasion, the first reference signal measurement occasion and the second reference signal measurement occasion having a same interference vector, as at 612 or 616 of FIG. 6. In an aspect, selecting the first reference signal measurement occasion and the second reference signal measurement occasion can comprise grouping the plurality of reference signal measurement occasions of the first cell into a plurality of groups, wherein each group of the plurality of groups contains a subset of the plurality of reference signal measurement occasions of the first cell that have a same interference vector, as at 610 of FIG. 6. In one example, a group of the plurality of groups having at least two reference signal measurement occasions is selected by the UE. In such a case, the first reference signal measurement occasion selected by the UE and the second reference signal measurement occasion selected by the UE are selected by the UE from the selected group. In one example, the UE selects, of the groups having at least two reference signal measurement occasions, a group having a maximum number of reference signal measurement occasions compared to remaining groups of the plurality of groups. In such an example, the first reference signal measurement occasion and the second reference signal measurement occasion are then selected by the UE from the selected group. In an aspect, means for performing the functionality of block 804 can, but not necessarily, include, for example, communication controller 314, measurement gap selector 324, processing system 316, and/or memory component 318 with reference to FIG. 3.

At 806, the UE (e.g., processing system 316) receives a first measurement gap corresponding to the first reference signal measurement occasion and a second measurement gap corresponding to the second reference signal measurement occasion, as at 614 or 618 of FIG. 6. In an aspect, means for performing the functionality of block 806 can, but not necessarily, include, for example, communication device 312, communication controller 314, processing system 316, and/or memory component 318 with reference to FIG. 3.

At 808, the UE (e.g., communication device 312 and/or communication controller 314) determines, during the first measurement gap corresponding to the first reference signal measurement occasion, a gain setting for performing a measurement of the reference signal transmitted during the second reference signal measurement occasion. At 810, the UE (e.g., communication device 312 and/or communication controller 314) performs, during the second measurement gap corresponding to the second reference signal measurement occasion, the measurement of the reference signal transmitted during the second reference signal measurement occasion using the determined gain setting. Then, the UE may report the measurement of the reference signal transmitted during the second reference signal measurement occasion to the location server. In an aspect, means for performing the functionality of blocks 808 and/or 810 can, but not necessarily, include, for example, communication device 312, communication controller 314, reference signal measurement module 326, processing system 316, and/or memory component 318 with reference to FIG. 3.

FIG. 9 illustrates an exemplary method 900 of a location server (e.g., location server 170) assisting a UE's performance of reference signal measurements of interfering cells during measurement gaps according to at least one aspect of the disclosure. At 902, the location server (e.g., processing system 401 or assistance data module 424) determines an interference vector for each of a plurality of reference signal measurement occasions of a first cell of a plurality of cells of an interfering cell set from which the UE can measure a reference signal, as at 704 of FIG. 7. In an aspect, means for performing the functionality of block 902 can, but not necessarily, include, for example, processing system 401, volatile memory 402, large capacity nonvolatile memory 403, communication device 404, drive 406, network 407, and/or assistance data module 424 with reference to FIG. 4.

At 904, the location server (e.g., processor 401 or assistance data module 424) selects a first reference signal measurement occasion and a second reference signal measurement occasion, the first reference signal measurement occasion and the second reference signal measurement occasion having a same interference vector, as at 710 or 714 of FIG. 7. In an aspect, selecting the first reference signal measurement occasion and the second reference signal measurement occasion can comprise grouping the plurality of reference signal measurement occasions of the first cell into a plurality of groups, wherein each group of the plurality of groups contains a subset of the plurality of reference signal measurement occasions of the first cell that have a same interference vector, as at 708 of FIG. 7. In one example, a group of the plurality of groups having at least two reference signal measurement occasions is selected by the UE. In such a case, the first reference signal measurement occasion selected by the UE and the second reference signal measurement occasion selected by the UE are selected by the UE from the selected group. In one example, the UE selects, of the groups having at least two reference signal measurement occasions, a group having a maximum number of reference signal measurement occasions compared to remaining groups of the plurality of groups. In such an example, the first reference signal measurement occasion and the second reference signal measurement occasion are then selected by the UE from the selected group. At 906, the location server (e.g., processor 401 or assistance data module 424) determines a first measurement gap corresponding to the first reference signal measurement occasion and a second measurement gap corresponding to the second reference signal measurement occasion, as at 712 or 716 of FIG. 7. In an aspect, means for performing the functionality of block 904 and/or 906 can, but not necessarily, include, for example, processing system 401, volatile memory 402, large capacity nonvolatile memory 403, drive 406, and/or assistance data module 424 with reference to FIG. 4.

At 908, the location server (e.g., communication device 404) sends assistance data to the UE to enable the UE to determine a gain setting for performing a measurement of the reference signal transmitted during the second reference signal measurement occasion and perform the measurement of the reference signal transmitted during the second reference signal measurement occasion using the determined gain setting. In an aspect, means for performing the functionality of block 908 can, but not necessarily, include, for example, processing system 401, volatile memory 402, large capacity nonvolatile memory 403, communication device 404, drive 406, network 407, and/or assistance data module 424 with reference to FIG. 4.

As will be appreciated, although the description of FIGS. 8 and 9 refers to “the reference signal,” as will be appreciated, this refers to a particular type of reference signal transmitted during a given type of measurement occasion, and not necessarily to the same physical signal emitted by an antenna. Thus, for example, when the UE determines, at 808, during the first measurement gap corresponding to the first reference signal measurement occasion, a gain setting for performing a measurement of the reference signal transmitted during the second reference signal measurement occasion, it means that the first cell schedules transmission of two different physical reference signals during two different measurement occasions, but the two different physical reference signals will be the same type of reference signal (e.g., PRS, CRS) and have the same properties, and can therefore be referred to as “the reference signal.”

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

In view of the descriptions and explanations above, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Accordingly, it will be appreciated, for example, that an apparatus or any component of an apparatus may be configured to (or made operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

Moreover, the methods, sequences, and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable (EEPROM), registers, hard disk, a removable disk, a compact disk (CD)-ROM, or any other form of storage medium known in the art. An exemplary storage medium is coupled to the processor such that the processor can read information from, and write information to, the storage medium. In the alternative, the storage medium may be integral to the processor (e.g., cache memory).

Accordingly, it will also be appreciated, for example, that certain aspects of the disclosure can include a computer-readable medium embodying a method for determining a position of a UE communicating over a shared communication medium in unlicensed spectrum.

While the foregoing disclosure shows various illustrative aspects, it should be noted that various changes and modifications may be made to the illustrated examples without departing from the scope defined by the appended claims. The present disclosure is not intended to be limited to the specifically illustrated examples alone. For example, unless otherwise noted, the functions, steps, and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A method for performing reference signal measurements of interfering cells at a user equipment (UE), comprising:
determining, by the UE, an interference vector for each of a plurality of reference signal measurement occasions of a first cell of a plurality of cells of an interfering cell set from which to measure a reference signal;
selecting, by the UE, a first reference signal measurement occasion and a second reference signal measurement occasion, the first reference signal measurement occasion and the second reference signal measurement occasion having a same interference vector;
receiving, by the UE, a first measurement gap corresponding to the first reference signal measurement occasion and a second measurement gap corresponding to the second reference signal measurement occasion;
during the first measurement gap corresponding to the first reference signal measurement occasion, determining, by the UE, a gain setting for performing a measurement of the reference signal transmitted during the second reference signal measurement occasion; and
during the second measurement gap corresponding to the second reference signal measurement occasion, performing, by the UE, the measurement of the reference signal transmitted during the second reference signal measurement occasion using the determined gain setting.

2. The method of claim 1, wherein the plurality of cells of the interfering cell set comprises a plurality of cells utilizing the same frequency and within communication range of the UE.

3. The method of claim 1, further comprising:
receiving, at the UE from a location server, assistance data for the plurality of cells of the interfering cell set.

4. The method of claim 3, further comprising:
reporting, by the UE, the measurement of the second reference signal transmitted during the second reference signal occasion to a location server.

5. The method of claim 1, wherein the interference vector for each of the plurality of reference signal measurement occasions comprises a set of values indicating whether remaining cells of the interfering cell set other than the first cell do or do not interfere with the reference signal measurement occasion of the plurality of reference signal measurement occasions of the first cell.

6. The method of claim 5, wherein a remaining cell of the plurality of cells other than the first cell does not interfere with a reference signal measurement occasion of the first cell if the remaining cell does not schedule data transmissions in one or more subframes during the reference signal measurement occasion.

7. The method of claim 6, wherein the one or more subframes during which the remaining cell does not schedule data transmissions comprise almost-blank subframes (ABS).

8. The method of claim 6, wherein the data transmissions comprise Physical Downlink Shared Channel (PDSCH) transmissions or Physical Downlink Control Channel (PDCCH) transmissions.

9. The method of claim 6, wherein the UE receives information identifying the one or more subframes from the remaining cell.

10. The method of claim 1, wherein the UE is located in a cell range extension (CRE) area of the serving cell.

11. The method of claim 1, wherein the first cell comprises a cell of a small cell base station within a coverage area of a macro cell base station.

12. The method of claim 1, wherein selecting the first reference signal measurement occasion and the second reference signal measurement occasion comprises:
grouping, by the UE, the plurality of reference signal measurement occasions of the first cell into a plurality of groups, wherein each group of the plurality of groups contains a subset of the plurality of reference signal measurement occasions of the first cell that have a same interference vector;
selecting, by the UE, a group of the plurality of groups having at least two reference signal measurement occasions; and
selecting, by the UE, the first reference signal measurement occasion and the second reference signal measurement occasion from the selected group.

13. The method of claim 12, wherein the selected group comprises a maximum number of reference signal measurement occasions compared to remaining groups of the plurality of groups.

14. The method of claim 1, further comprising:
determining, by the UE, a measurement gap configuration for the first cell.

15. A method for assisting a user equipment (UE) to perform reference signal measurements of interfering cells, comprising:
determining, by the location server, an interference vector for each of a plurality of reference signal measurement occasions of a first cell of a plurality of cells of an interfering cell set from which the UE can measure a reference signal;
selecting, by the location server, a first reference signal measurement occasion and a second reference signal measurement occasion, the first reference signal measurement occasion and the second reference signal measurement occasion having a same interference vector;
determining, by the location server, a first measurement gap corresponding to the first reference signal measurement occasion and a second measurement gap corresponding to the second reference signal measurement occasion; and
sending, by the location server, assistance data to the UE to enable the UE to determine a gain setting for performing a measurement of the reference signal transmitted during the second reference signal measurement occasion and perform the measurement of the reference signal transmitted during the second reference signal measurement occasion using the determined gain setting.

16. The method of claim 15, wherein the plurality of cells of the interfering cell set comprises a plurality of cells utilizing the same frequency and within communication range of the UE.

17. The method of claim 15, further comprising:
receiving, at the location server from the UE, the measurement of the reference signal measurement occasion of the first cell made during the second measurement gap.

18. The method of claim 15, further comprising:
receiving, at the location server from the UE, information identifying one or more subframes during which one or more remaining cells do not schedule data transmissions, wherein the one or more remaining cells comprise one or more cells of the plurality of cells other than the first cell that do not interfere with a reference signal measurement occasion of the first cell.

19. The method of claim 18, wherein the one or more subframes during which the plurality of cells do not schedule data transmissions comprise almost-blank subframes (ABS).

20. The method of claim 19, wherein the data transmissions comprise Physical Downlink Shared Channel (PDSCH) transmissions or Physical Downlink Control Channel (PDCCH) transmissions.

21. The method of claim 15, wherein the interference vector for each of the plurality of reference signal measurement occasions comprises a set of values indicating whether remaining cells of the interfering cell set other than the first cell do or do not interfere with the reference signal measurement occasion of the plurality of reference signal measurement occasions of the first cell.

22. The method of claim 15, wherein selecting the first reference signal measurement occasion and the second reference signal measurement occasion comprises:
grouping, by the location server, the plurality of reference signal measurement occasions of the first cell into a plurality of groups, wherein each group of the plurality of groups contains a subset of the plurality of reference signal measurement occasions of the first cell that have a same interference vector;
selecting, by the location server, a group of the plurality of groups having at least two reference signal measurement occasions; and
selecting, by the location server, the first reference signal measurement occasion and the second reference signal measurement occasion from the selected group.

23. The method of claim 22, wherein the selected group comprises a maximum number of reference signal measurement occasions compared to remaining groups of the plurality of groups.

24. The method of claim 15, wherein the UE is located in a cell range extension (CRE) area of the serving cell.

25. The method of claim 15, wherein the first cell comprises a cell of a small cell base station within a coverage area of a macro cell base station.

26. An apparatus for performing reference signal measurements of interfering cells at a user equipment (UE), comprising:
at least one processor of the UE configured to:
determine an interference vector for each of a plurality of reference signal measurement occasions of a first cell of a plurality of cells of an interfering cell set from which to measure a reference signal;
select a first reference signal measurement occasion and a second reference signal measurement occasion, the first reference signal measurement occasion and the second reference signal measurement occasion having a same interference vector; and
receive a first measurement gap corresponding to the first reference signal measurement occasion and a second measurement gap corresponding to the second reference signal measurement occasion; and
a transceiver of the UE configured to:
determine, during the first measurement gap corresponding to the first reference signal measurement occasion, a gain setting for performing a measurement of the reference signal transmitted during the second reference signal measurement occasion; and
perform, during the second measurement gap corresponding to the second reference signal measurement occasion, the measurement of the reference signal transmitted during the second reference signal measurement occasion using the determined gain setting.

27. The apparatus of claim 26, wherein the interference vector for each of the plurality of reference signal measurement occasions comprises a set of values indicating whether remaining cells of the interfering cell set other than the first cell do or do not interfere with the reference signal measurement occasion of the plurality of reference signal measurement occasions of the first cell.

28. The apparatus of claim 26, wherein the at least one processor being configured to select the first reference signal measurement occasion and the second reference signal measurement occasion comprises the at least one processor being configured to:
group the plurality of reference signal measurement occasions of the first cell into a plurality of groups, wherein each group of the plurality of groups contains a subset of the plurality of reference signal measurement occasions of the first cell that have a same interference vector;
select a group of the plurality of groups having at least two reference signal measurement occasions; and
select the first reference signal measurement occasion and the second reference signal measurement occasion from the selected group.

29. The apparatus of claim 28, wherein the selected group comprises a maximum number of reference signal measurement occasions compared to remaining groups of the plurality of groups.

30. An apparatus for assisting a user equipment (UE) to perform reference signal measurements of interfering cells, comprising:
at least one processor of a location server configured to:
determine an interference vector for each of a plurality of reference signal measurement occasions of a first cell of a plurality of cells of an interfering cell set from which the UE can measure a reference signal;
select a first reference signal measurement occasion and a second reference signal measurement occasion, the first reference signal measurement occasion and the second reference signal measurement occasion having a same interference vector; and
determine a first measurement gap corresponding to the first reference signal measurement occasion and a second measurement gap corresponding to the second reference signal measurement occasion; and
a communication device of the location server configured to:
send assistance data to the UE to enable the UE to determine a gain setting for performing a measurement of the reference signal transmitted during the second reference signal measurement occasion and perform the measurement of the reference signal transmitted during the second reference signal measurement occasion using the determined gain setting.
